(19) United States
(12) Patent Application Publication
(10) Pub. No.: US 2004/0022687 A1
(43) Pub. Date: Feb. 5, 2004

(54) Device and process for collecting and releasing saliva

(76) Inventors: Thomas Wuske, Malente (DE); Torben Bauch, Flensburg (DE); Rainer Polzius, Lubeck (DE); Jessica Mahn, Dunkelsdorf (DE)

Correspondence Address: McGLEW AND TUTTLE, P.C., SCARBOROUGH STATION, SCARBOROUGH, NY, 10510-0827, US

(21) Appl. No.: 10/417,646

(22) Filed: Apr. 17, 2003

(30) Foreign Application Priority Data
Jul. 31, 2002 (DE) 102 34 832.4-35

(51) Int. Cl. B01L 11/00; G01N 1/00

(52) U.S. Cl. 422/99; 422/101; 436/174

(57) ABSTRACT

A device for collecting and releasing a sample liquid, especially saliva as well as a system and method are provided. The device and system obtains and provides a defined saliva sample, i.e., a filtered and homogeneously mixed saliva sample of a predetermined volume, in the simplest possible manner. The device has a sampling tip (2) made of an incompressible and porous material, which is moved with its mouthpiece (4) in the mouth of a test subject for 1 to 2 minutes and collects saliva based on the capillary action. A reagent depot containing reagent liquid is subsequently cut up by a puncturing cylinder (9) at the sample collector, and the reagent liquid then enters the cavity (10) of the sampling tip (2). Finally, the complete pushing together of the pneumatic cylinder (26) and the cylinder tube (1) of the sample collector finally presses the saliva and the reagent liquid present in the cavity (10) through the sampling tip (2) and the filter reactor (21), which is fitted thereto in a positive-locking manner and is likewise incompressible and porous with a smaller mean pore size, so that saliva and liquid are discharged as droplets (40) in a filtered and mixed manner.

### FIELD OF THE INVENTION

The present invention pertains to a device and a process for collecting and releasing a sample liquid, especially saliva.

### BACKGROUND OF THE INVENTION

Saliva has acquired increasing significance as an information carrier, especially for medical tests as well as for the detection of administered or ingested substances, especially drugs or habit-forming drugs. The testing of saliva is preceded by the taking and providing of a saliva sample.

A device for collecting and releasing saliva for diagnostic purposes has been known from DE 197 48 331 C1. The device comprises a section which collects and squeezes out the saliva sample and is located displaceably in a container. The container is closed at one of its ends and can be opened at its other end by lifting a closing cap with an integrated filter. The container is preferably designed as a bellows. Saliva first enters the bellows via the opened closing cap and is taken up by the porous section. Pushing together the bellows with the closing cap closed presses together the porous section, and the saliva taken up before is discharged to the outside, filtered by the filter of the closed closing cap. The piston is subsequently introduced into a syringe, in which a diluting liquid as well as additional reagents are contained.

### SUMMARY OF THE INVENTION

The object of the present invention is to provide a device and a process for collecting and releasing a sample liquid, especially saliva, with which simple sampling and supplying of a defined saliva sample is possible. A defined saliva sample is defined as a filtered, homogeneously mixed saliva sample of a predetermined volume.

According to the invention, a device is provided for collecting and releasing a sample liquid. The device includes a sample collector with a porous and incompressible sampling tip for collecting the sample liquid in the sampling tip. A pneumatic means is provided which generates an overpressure in a cavity of the sampling tip.

According to another aspect of the invention, a process is provided for collecting and releasing a sample liquid. The process includes the steps of collecting the sample liquid by a porous and incompressible sampling tip and generating an overpressure in a cavity of the sampling tip by a pneumatic means. The sample liquid is released through the sampling tip.

The device and the process for collecting and releasing a sample liquid are especially suitable for collecting and releasing a saliva sample. Other human body fluids, such as blood, blood plasma, urine or sweat may also be considered as sample liquids. The device comprises a sample collector with a sampling tip made of a porous and incompressible material, which is used to collect the sample liquid. The sampling tip is introduced into the oral cavity of a test subject in the case of a saliva sample. The porosity of the sampling tip brings about the uptake of saliva based on capillary forces. Furthermore, a pneumatic means is part of the device, which generates an overpressure in a cavity of the sampling tip and thus delivers the sample liquid from the sampling tip. A cavity is defined quite generally as a closed space in the sample collector, which is located opposite the side of the sampling tip from which the sample liquid is released from the sample collector by means of the pneumatic means. For example, the cavity may be designed as the interior of a sleeve-like sampling tip.

The pneumatic means may be operated, e.g., mechanically or by means of a compressed air reserve. In the first case, the pneumatic means can be displaced relative to the sample collector, comparably to a reciprocating pump, the pneumatic means being designed essentially as a pneumatic cylinder, which encloses the sample collector during the pushing together, or as a pneumatic plunger, which penetrates the sample collector during the pushing together.

In another preferred embodiment, the sampling tip has an indicator zone outside the mouthpiece which comes into contact with the mouth of a test subject. The indicator zone contains a moisture indicator, which indicates the successful collection of sample liquid. If the moisture indicator is an indicator dye, it indicates a change in color in the presence of moisture, and if it is a material that expands in the presence of moisture, e.g., a sponge, the moisture is indicated by a corresponding change in length.

In case of a mechanically operating pneumatic means, the admission of a reagent liquid from a reagent container may be brought about, besides by an overpressure, during the pressing together of the pneumatic means and the sample collector. A pneumatic unit has, e.g., a reagent depot for this purpose, which is sealed with a foil and is cut up over the edge of the cylinder tube of the sample collector, designed as a puncturable cylinder. A pneumatic plunger has, e.g., a puncturing tip at its lower end, with which the membrane of a reagent capsule located in the sample collector is punctured.

Other advantageous embodiments of the present invention comprise a system which comprises a device according to the present invention in one of the preferred embodiments and, in addition, a filter mixer with a porous and incompressible filter reactor. The sampling tip and the filter reactor are connected to one another in a positive-locking manner and thus form a unit of an approximately constant thickness, through which the sample liquid as well as the reagent liquid can be discharged to the outside. The mean pore size of the sampling tip and of the filter reactor is between 0.2 μm and 200 μm, the mean pore size of the filter reactor being selected to be smaller, e.g., between 7 μm and 12 μm, than that of the sampling tip, which is, e.g., between 15 μm and 45 μm. Filtering and mixing are facilitated by the pore size decreasing progressively for the sample liquid and the reagent liquid on the way through the sampling tip and the filter reactor.

The process according to the present invention for collecting and releasing a sample liquid is advantageously followed by the analysis and the evaluation of the sample liquid, which is optionally mixed with a reagent liquid from a reagent container.

The present invention will be described below on the basis of the embodiment examples shown in the figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 a is a side view of a sample collector;

FIG. 1b is a longitudinal section of the sample collector from FIG. 1a along line A-A;

FIG. 2 is a longitudinal section of a filter mixer;

FIG. 3 is a longitudinal section of a pneumatic unit;

FIG. 4 is a longitudinal section of a pneumatic plunger;

FIG. 5a is a side view of a first alternative of a system with a sample collector, a filter mixer and a pneumatic unit;

FIG. 5b is a longitudinal section of the system according to FIG. 5a along line A-A, and

FIG. 6 is a longitudinal section of a second alternative of a system with a sample collector, a filter mixer and a pneumatic plunger.

### DESCRIPTION OF THE PREFERRED EMBODIMENTS

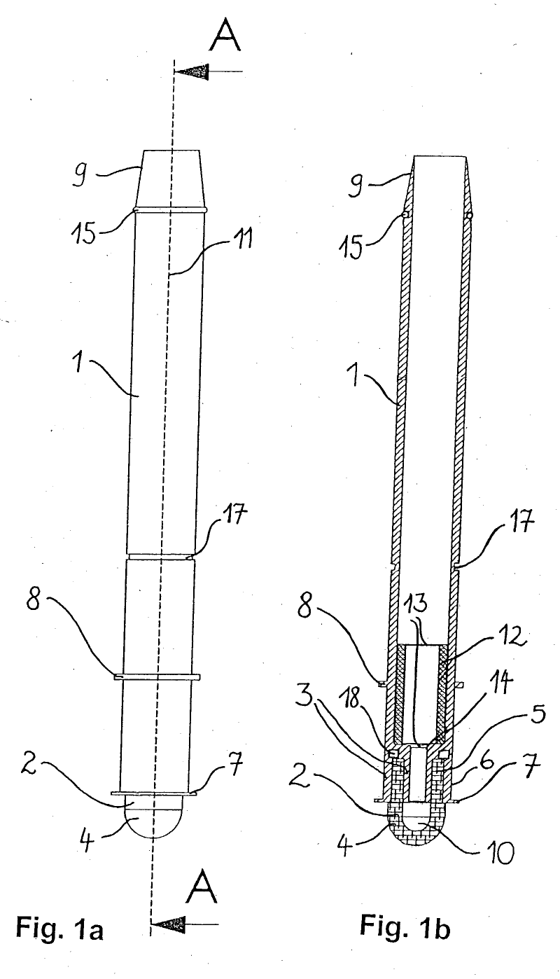

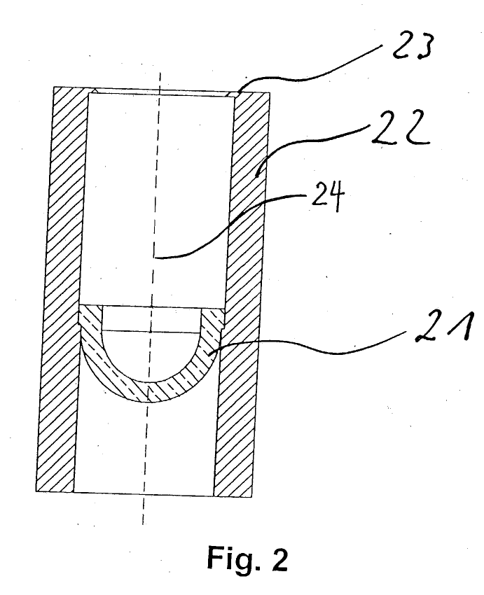

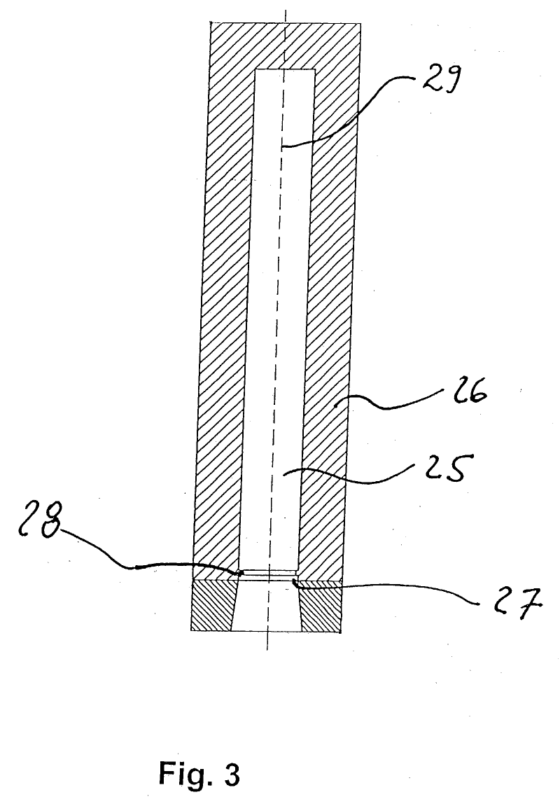

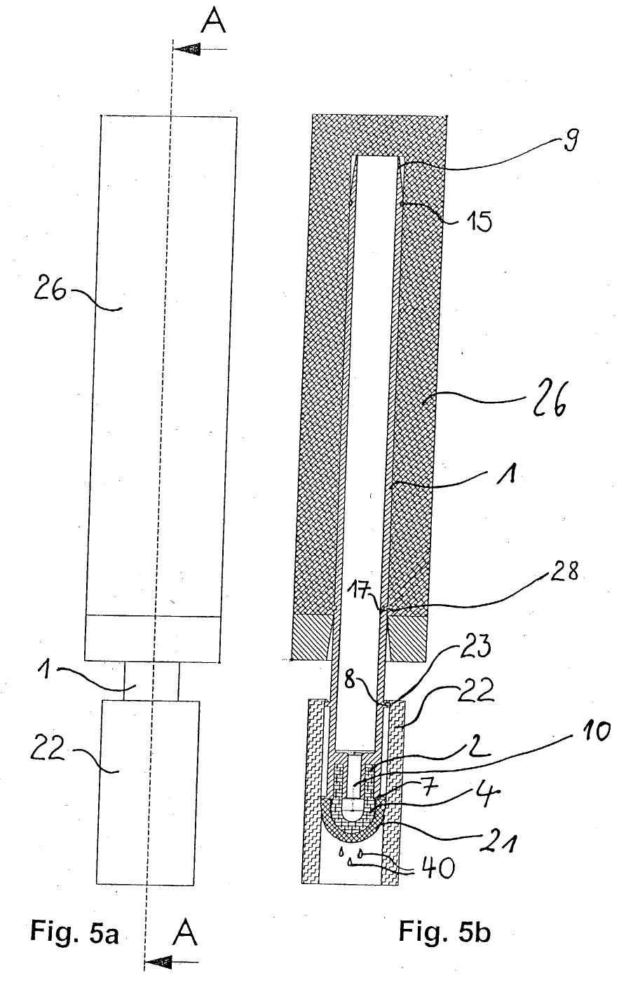

Referring to the drawings in particular, FIG. 1 a shows a side view of a preferred embodiment of a sample collector at right angles to its longitudinal axis 11. The sample collector is rotationally symmetrical to the longitudinal axis 11 and comprises a cylinder tube 1, which is joined by a puncturing cylinder 9 at the top end and by a sampling tip 2 at the lower end. The cylinder tube 1 consists of a thermoplast that can be subjected to injection molding, e.g., polypropylene or polyethylene, a machinable duroplast or a metal. The sampling tip 2 is closed off with a hemispherical mouthpiece 4, which is introduced into the mouth of a test subject, not shown. A sealing lamella 7 extending around the cylinder tube 1 in a ring-shaped pattern as well as a holding bead 8 extending in a ring-shaped pattern over it guarantee a reliable and accurately positioned sealing against the filter mixer shown in FIG. 2. The sealing formed by the sample collector and the filter mixer can be recognized in FIG. 5b. A groove 17 extending in a ring-shaped pattern around the cylinder tube 1 enables the flange 28 of the pneumatic unit in FIG. 3 to snap in. The pneumatic unit snapped into the groove 17 of the sample collector is shown in FIG. 5b. A recess with an O-ring 15 is provided in the upper area of the cylinder tube 1 below the puncturing cylinder 9 to ensure airtight closure between the sample collector and the pneumatic unit shown in FIG. 3.

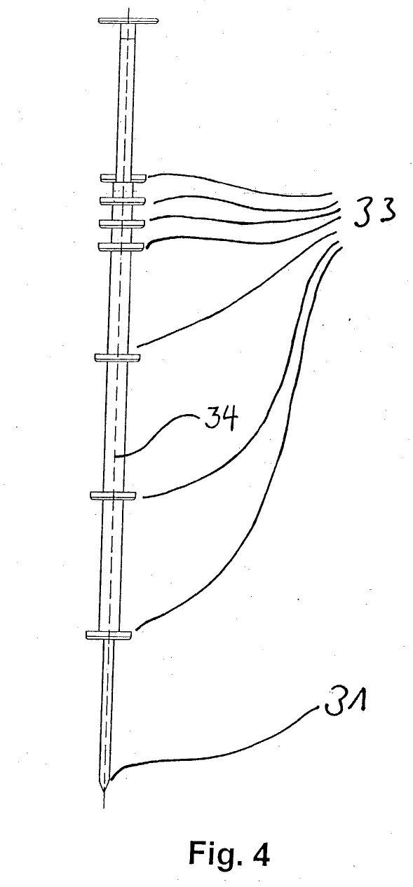

FIG. 1b shows the longitudinal section of the sample collector according to FIG. 1a along line A-A. The cylinder tube 1 opens downwardly into the upper part of the sampling tip 2 via a bracket 3 of a shaft-like design. The bracket 3 is used, moreover, to separate the mouthpiece, 4 and to close off the sampling tip 2 from the indicator zone 5, which forms the part of the sampling tip 2 above the mouthpiece 4. The bracket 3 is transparent in the collection area for the sampling tip 2 in order to make it possible to indicate the moistening through a window. The sampling tip 2 is hollow on the inside and has a constant wall thickness. The cavity 10 in the sampling tip 2 can accommodate a reagent liquid introduced by the pneumatic unit according to FIG. 3. The sampling tip 2 is made of an incompressible and porous carrier material, e.g., sintered ceramic or sintered plastic such as polyethylene, polypropylene, polytetrafluoroethylene, polyvinylidene fluoride or polyurethane. The mean pore size of the carrier material is between 0.2 and 200 μm and preferably between 15 μm and 45 μm, and it is always greater than that of the complementary filter reactor 21 of the filter mixer shown in FIG. 2. The carrier material of the sampling tip 2 has a hydrophilic surface as a consequence of a physical treatment or chemical coating with anionic, cationic or nonionic wetting agents. The physical treatment may be carried out with an ion source. The wetting agents are food-grade wetting agents, e.g., nonionic taurates. In addition, the carrier material may be treated with additives that bring about a concentration, improved solubility or stabilization of an analyte to be detected. The stabilization may be achieved, e.g., by complexing. The indicator zone 5 of the sampling tip 2 is not accessible to the mouth of the test subject. The indicator zone 5 is prepared by applying a liquid indicator dye to the upper area of the sampling tip 2 and allowing it to dry there. A change in the color of the indicator substance, which can be perceived through the window 6, may indicate, e.g., whether the saliva sample has reached the necessary volume. Suitable indicator dyes include those that indicate a change in the pH value or detect the enzyme amylase present in the saliva. A reagent liquid, which enters the cavity 10 when the puncturing tip 31 of the pneumatic plunger according to FIG. 4 punctures the membrane 13 at the upper and lower ends of the reagent capsule 12, is contained in a reagent capsule 12 optionally arranged in the cylinder tube 1 with a perforable membrane 13 each at the upper and lower ends. The reagent capsule 12 is positioned in the cylinder tube 1 by means of a stop 14.

It shall be pointed out here that a pneumatic unit according to FIG. 3 or a pneumatic plunger according to FIG. 4 is used alternatively at the sample collector according to FIG. 1b. If a pneumatic unit according to FIG. 3 is selected, the reagent liquid is introduced via a reagent depot 25. In case of a pneumatic plunger according to FIG. 4, the reagent liquid is discharged from a reagent capsule 12 in the sample collector. It is decisive in both cases, i.e., in case of the use of both a pneumatic unit and a pneumatic plunger, that an overpressure be generated in the cavity 10, which presses the saliva present in the porous wall of the mouthpiece 4 through the wall of the mouthpiece 4 and of the filter reactor 21 of the filter mixer according to FIG. 2 to the outside. The additional release of a reagent liquid is not absolutely necessary. Besides the indication by the indicator zone 5 of whether the saliva sample having penetrated the wall of the mouthpiece 4 has reached the necessary volume, this indication may also be brought about by means of a sponge 18, which is located in the cylinder tube 1 above the sampling tip 2. The sponge 18 consists, e.g., of compressed and colored viscose or cellulose, which expands several times on contact with the saliva. A corresponding change in the length of the sponge 18 on contact with the saliva is visible through the window 6.

FIG. 2 shows a longitudinal section of a filter mixer through its longitudinal axis 24, in relation to which it is rotationally symmetrical. It comprises a guide cylinder 22 and a hemispherical filter reactor 21, which is open upwardly and is inserted at its circular edge into the guide cylinder 22 such that the filter mixer is closed downwardly. The same materials may be used for the guide cylinder 22 as for the cylinder tube 1 of the sample collector according to FIG. 1a. An inwardly protruding, annularly extending holding edge 23 at the upper end of the guide cylinder 22 engages the filter mixer via the holding bead 8 during the fitting together of the sample collector according to FIG. 1 a with the filter mixer such that the sample collector and the filter mixer snap into each other.

When the filter mixer and the sample collector are fitted together, the filter reactor 21 forms a positive-locking connection with the mouthpiece 4 of the sample collector. The same materials may be used for the filter reactor 21 as for the sampling tip 2 of the sample collector according to FIG. 1a. A mean pore size between 0.2 μm and 200 μm is selected in this case as well. It shall be ensured that the mean pore size of the filter reactor 21 is smaller than that of the sampling tip 2. It is preferably between 7 μm and 12 μm. Dry reagents may be considered for use as additives for the material of the filter reactor 21. These are, e.g., antibodies, enzymes, catalysts, mediators, tracer chemicals, stabilizers and buffers.

FIG. 3 shows the longitudinal section of a pneumatic unit through its longitudinal axis 29, in relation to which the pneumatic unit is rotationally symmetrical. It has a pneumatic cylinder 26, which is closed at the top and in which a reagent depot 25 with a liquid is contained, which depot is closed to the outside by a foil 26 sealed in an airtight manner. A ring-shaped flange 28, which snaps into the groove 17 when the pneumatic unit is fitted together with the sample collector shown in FIG. 1b, extends in the lower area of the pneumatic cylinder 26 on the inner side. The inner side of the pneumatic cylinder 26 widens in the lower area toward the edge, so that the tubular wall of the pneumatic cylinder 26 converges in the downwardly direction. This embodiment makes possible a simpler assembly of the pneumatic unit and the sample collector.

FIG. 4 shows the longitudinal section of a pneumatic plunger through its longitudinal axis 34. The pneumatic plunger is rotationally symmetrical to the longitudinal axis 34. It may be fitted together with the sample collector shown in FIG. 1b and represents an alternative to a pneumatic unit according to FIG. 3. A puncturing tip 31, which perforates the membrane 13 at the upper and lower ends of the reagent capsule 12 during the fitting together of the pneumatic plunger and the sample collector, is located at the lower end. The lamellae 33 arranged in an annular patterns at different heights around the pneumatic plunger are used for sealing against the inner wall of the cylinder tube 1 of the sample collector.

FIG. 5a shows a side view of a first alternative of a system with a sample collector, a filter mixer and a pneumatic unit.

FIG. 5b shows the longitudinal section of the system according to FIG. 5a along line A-A. A saliva sample was already released and has entered the wall of the mouthpiece 4. The sample collector and the filter mixer are plugged together, and the holding edge 23 of the filter mixer engages the holding bead 8 of the sample collector, and the mouthpiece 4 of the sample collector and the filter reactor 21 of the filter mixer form a positive-locking connection. The pneumatic unit was fitted to the sample collector, so that the puncturing cylinder 9 has already punctured the foil 27 of the pneumatic unit, and the reagent liquid has entered the cavity 10 of the sampling tip from the reagent depot 25. The pneumatic unit was fitted farther onto the sample collector until the flange 28 snapped into the groove 17, so that overpressure has meanwhile built up in the cylinder tube 1 and the cavity 10, which presses through the saliva, the reagent liquid and optionally additional substances through the mouthpiece 4 and the filter reactor 21 in the downward direction in a filtered, mixed and correspondingly conditioned manner, which is indicated by the droplets 40 dropping off.

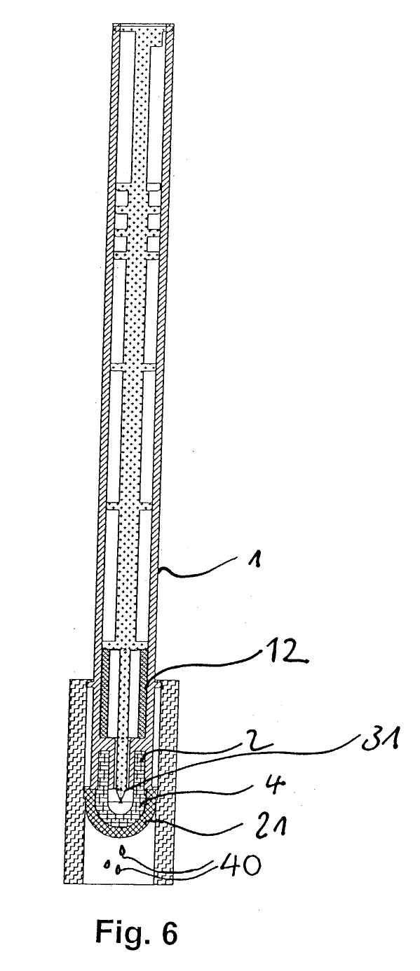

FIG. 6 shows a longitudinal section of a second alternative of a system with a sample collector, a filter mixer and a pneumatic plunger. The saliva sample was already released in this case as well. The sample collector and the filter mixer have formed a plug-in connection, which corresponds to that in FIG. 5b. The pneumatic plunger was introduced into the sample collector, and the puncturing tip 31 has punctured the membrane 13, not shown here, at the upper and lower ends of the reagent capsule 12, so that the reagent liquid has already entered the cavity 10. The pneumatic plunger was introduced into the sample collector to the extent that the overpressure generated thereby presses the saliva, the reagent liquid and optionally additional substances through the mouthpiece 4 and the filter reactor 21 in the downward direction in a filtered, mixed and correspondingly conditioned manner, which is indicated by the droplets 40 dropping off in this case as well.

While specific embodiments of the invention have been shown and described in detail to illustrate the application of the principles of the invention, it will be understood that the invention may be embodied otherwise without departing from such principles.

What is claimed is:

1. A device for collecting and releasing a sample liquid, the device comprising:
a sample collector with a porous and incompressible sampling tip for collecting the sample liquid in the sampling tip, the sampling tip having a cavity; and
a pneumatic device which generates an overpressure in said cavity of the sampling tip.

2. A device in accordance with claim 1, wherein the pneumatic device is displaceable relative to the sample collector, and pushing together of the pneumatic device and the sample collector generates an overpressure in the cavity of the sampling tip.

3. A device in accordance with claim 1, wherein the sampling tip has an indicator zone and a moisture indicator indicating the uptake of the sample liquid.

4. A device in accordance with claim 3, wherein the moisture indicator is an indicator dye that shows a change in color in the presence of moisture.

5. A device in accordance with claim 3, wherein the moisture indicator is a material that expands in the presence of moisture.

6. A device in accordance with claim 2, further comprising a reagent container and a device for causing a penetration of a liquid from said reagent container into said cavity during a pushing together of said pneumatic device and said sample collector.

7. A system, comprising:
a device for collecting and releasing a sample liquid and including a sample collector with a porous and incompressible sampling tip for collecting the sample liquid in the sampling tip, the sampling tip having a cavity and a pneumatic device which generates an overpressure in said cavity of the sampling tip; and
a filter mixer with a porous and incompressible filter reactor, said sampling tip and said filter reactor being complementary and forming a positive-locking connection of an approximately constant thickness.

8. A system in accordance with claim 7, further wherein a mean pore size of the sampling tip and that of the filter reactor is between 0.2 μm and 200 μm each, and a mean pore size of the sampling tip is greater than that of the filter reactor.

9. A system in accordance with claim 7, wherein the mean pore size of the sampling tip is between 15 μm and 45 μm and the mean pore size of the filter reactor is between 7 μm and 12 μm.

10. A process for collecting and releasing a sample liquid, the process comprising the steps of:
collecting a sample liquid by a porous and incompressible sampling tip; and
generating an overpressure in a cavity of the sampling tip using a pneumatic device to release the sample liquid through the sampling tip.

11. A process in accordance with claim 10, further comprising the step of:
sending the sample liquid to an analyzing and evaluating unit.

12. A process in accordance with claim 10, wherein the pneumatic device is used to generate the overpressure by displacing the pneumatic device relative to the sample collector and pushing the pneumatic device and the sample collector together to generate the overpressure in the cavity of the sampling tip.

13. A process in accordance with claim 10, wherein the sampling tip has an indicator zone and a moisture indicator indicating the uptake of the sample liquid.

14. A process in accordance with claim 13, wherein the moisture indicator is an indicator dye that shows a change in color in the presence of moisture.

15. A process in accordance with claim 13, wherein the moisture indicator is a material that expands in the presence of moisture.

16. A process in accordance with claim 12, further comprising the steps of providing a reagent container and causing a penetration of a liquid from said reagent container into said cavity during a pushing together of the pneumatic device and said sample collector.

17. A process in accordance with claim 12, further comprising the steps of providing a filter mixer with a porous and incompressible filter reactor, said sampling tip and said filter reactor being complementary and forming a positive-locking connection.

18. A process in accordance with claim 17, wherein a mean pore size of the sampling tip and that of the filter reactor is between 0.2 μm and 200 μm each, and a mean pore size of the sampling tip is greater than that of the filter reactor.

19. A system in accordance with claim 17, wherein the mean pore size of the sampling tip is between 15 μm and 45 μm and the mean pore size of the filter reactor is between 7 μm and 12 μm.
